(19) United States
(12) Patent Application Publication
(10) Pub. No.: US 2011/0157516 A1
(43) Pub. Date: Jun. 30, 2011

(54) ILLUMINATING DEVICE AND LIQUID CRYSTAL DISPLAY DEVICE PROVIDED WITH THE SAME

(75) Inventor: Eiji Nittou, Osaka-shi (JP)

(73) Assignee: SHARP KABUSHIKI KAISHA, Osaka-shi, Osaka (JP)

(21) Appl. No.: 13/059,232

(22) PCT Filed: Jun. 15, 2009
(86) PCT No.: PCT/JP2009/060844

§ 371 Date: Feb. 16, 2011

(30) Foreign Application Priority Data
Sep. 11, 2008 (JP) 2008-232955

(51) Int. Cl. G02F 1/13357; F21V 21/00; F21V 7/00

(52) U.S. Cl. 349/62; 362/249.01; 362/249.14; 362/240; 349/61

(57) ABSTRACT

Provided is an illuminating device wherein luminance deterioration due to a change of visual angle is suppressed. An illuminating device (10) is provided with a plurality of linear light sources (2) which are arranged from one end of the case member (1) toward the other end. Each of the linear light sources (2) grouped as a first light source (2a) has a light emitting direction tilted to one end of the case member (1) with respect to a Z direction. Each of the linear light sources (2) grouped as a second light source (2b) has a light emitting direction tilted to the other end of the case member (1) with respect to the Z direction.

### TECHNICAL FIELD

The present invention relates to an illuminating device and a liquid crystal display device provided with the same.

### BACKGROUND ART

Conventionally, an illuminating device that can output planar light has been known and used as a backlight for illuminating a liquid crystal display panel of a liquid crystal display device. As such a backlight for use in a liquid crystal display device, there exists a backlight with a configuration in which a light source thereof is disposed immediately below a liquid crystal display panel, which is referred to as a direct type backlight (see, for example, Patent Document 1).

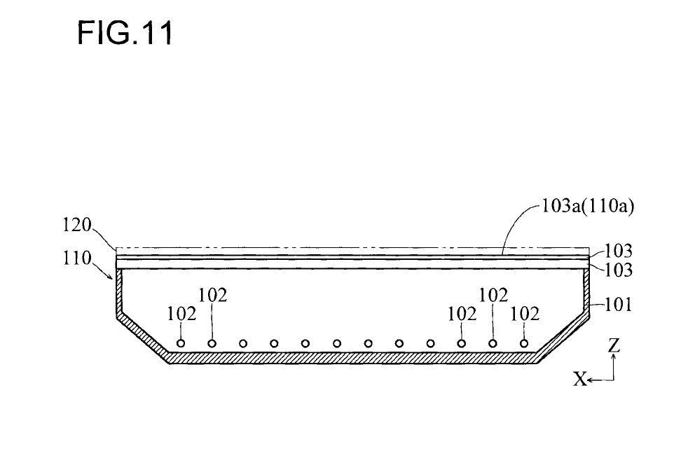

FIG. 11 is a simplified diagram of an example of a direct type backlight (illuminating device) according to the conventional technique. The following describes, as an example, the configuration of the conventional direct type backlight (illuminating device) with reference to FIG. 11.

In a conventional direct type backlight (illuminating device) 110, as shown in FIG. 11, a plurality of straight tube type fluorescent tubes 102 as a light source are housed in a case member 101 having a light output opening on a side on which a liquid crystal display panel 120 is installed. The plurality of fluorescent tubes 102 are disposed so that they each extend in a direction perpendicular to the plane of FIG. 11 and are arranged at a predetermined spacing from each other in a direction (X-direction) orthogonal to the extending direction of the fluorescent tubes 102. Furthermore, diffusion members (a diffusion plate, a diffusion sheet, etc.) 103 are disposed so as to close the light output opening of the case member 101, and an uppermost surface 103a of the diffusion members 103 acts as a light output surface (surface through which light for illuminating the liquid crystal display panel 120 is outputted) 110a of the direct type backlight 110.

### LIST OF CITATIONS

### Patent Literature

Patent Document 1: JP-A-2005-285620

### SUMMARY OF THE INVENTION

### Technical Problem

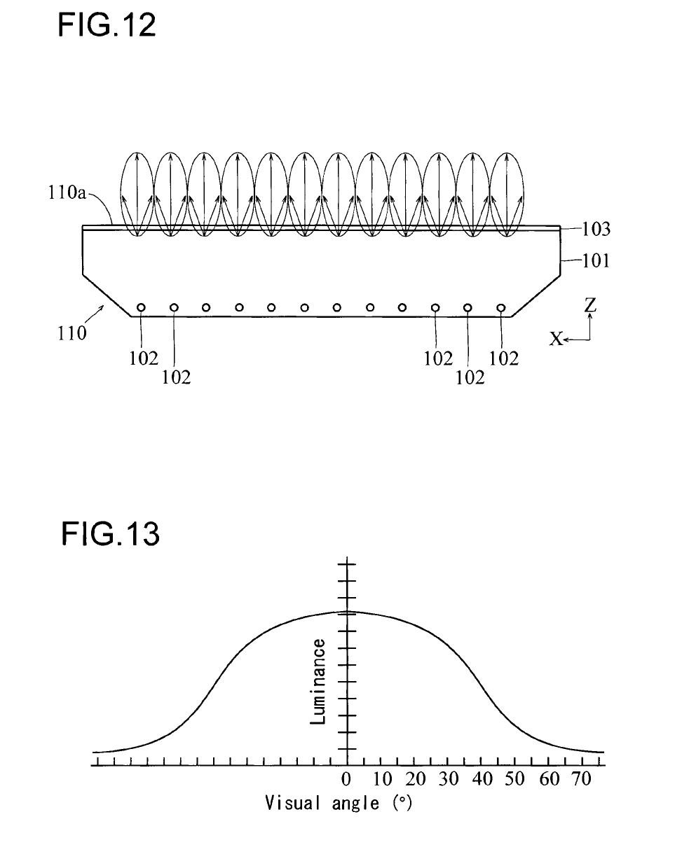

In the above-described conventional direct type backlight (illuminating device) 110, however, as shown in FIGS. 12 and 13, while light outputted in the front direction (normal direction to the light output surface 110a of the direct type backlight 110 (Z-direction)) exhibits a high luminance, light outputted in a direction inclined with respect to the front direction exhibits a low luminance. Because of this, there is a trouble that while high luminance can be obtained under a visual angle in the front direction (in the vicinity of 0° in FIG. 13), the luminance obtained under a visual angle in a direction deviated from the front direction is deteriorated. That is, the conventional direct type backlight 110 presents a problem that luminance deterioration occurs due to variations in visual angle. In FIG. 12, the length of each arrow represents light luminance.

In order to solve the above-described problem, it is an object of this invention to provide an illuminating device that can suppress luminance deterioration due to variations in visual angle, and a liquid crystal display device provided with the same.

### Solution to the Problem

In order to achieve the above-described object, an illuminating device according to a first aspect of this invention includes: a case member that has a light output opening on a side on which an illuminated body is installed; a plurality of light sources that, in a state of being housed in the case member, are disposed immediately below the illuminated body and arranged from the side of one end of the case member toward the side of the other end; and an optical sheet that is disposed so as to close the light output opening of the case member and whose surface facing the side of the illuminated body acts as a light output surface. In the illuminating device, the plurality of light sources are categorized into at least two types that are a first light source and a second light source. Each of a group of light sources among the plurality of light sources, which are categorized into the first light source, has a light emission direction inclined to the side of the one end of the case member with respect to the normal direction to the light output surface, and each of a group of light sources among the plurality of light sources, which are categorized into the second light source, has a light emission direction inclined to the side of the other end of the case member with respect to the normal direction to the light output surface.

In the illuminating device according to the first aspect, as described above, the plurality of light sources are categorized into at least two types that are the first light source and the second light source. Further, each of the group of light sources among the plurality of light sources, which are categorized into the first light source, is set to have a light emission direction inclined to the side of the one end of the case member with respect to the normal direction to the light output surface, and each of the group of light sources among the plurality of light sources, which are categorized into the second light source, is set to have a light emission direction inclined to the side of the other end of the case member with respect to the normal direction to the light output surface. By this configuration, while the luminance of light outputted in the front direction (normal direction to the light output surface) is somewhat decreased, the luminance of light outputted in a direction inclined with respect to the front direction is increased. Thus, even under a visual angle in a direction deviated from the front direction, the occurrence of the trouble that the luminance is deteriorated can be suppressed. That is, luminance deterioration due to variations in visual angle can be suppressed, which allows excellent luminance to be obtained under a wider range of visual angles.

In the above-described illuminating device according to the first aspect, preferably, the plurality of light sources are arranged from the side of the one end of the case member toward the side of the other end so that the group of light sources categorized into the first light source and the group of light sources categorized into the second light source alternate with each other one by one. According to this configuration, even if the light emission direction varies between the group of light sources categorized into the first light source and the group of light sources categorized into the second light source, the occurrence of luminance variations can be suppressed.

In the above-described illuminating device according to the first aspect, preferably, each of the plurality of light sources includes a luminous body that generates light and a reflection member that reflects light generated by the luminous body. Further, a light reflection direction of the reflection member included in each of the group of light sources categorized into the first light source is inclined to the side of the one end of the case member with respect to the normal direction to the light output surface, and a light reflection direction of the reflection member included in each of the group of light sources categorized into the second light source is inclined to the side of the other end of the case member with respect to the normal direction to the light output surface. According to this configuration, it is easily possible to set so that each of the group of light sources categorized into the first light source has a light emission direction inclined to the side of the one end of the case member with respect to the normal direction to the light output surface, and each of the group of light sources categorized into the second light surface has a light emission direction inclined to the side of the other end of the case member with respect to the normal direction to the light output surface.

In the above-described configuration, the luminous body may be a fluorescent tube or a light-emitting diode element.

Furthermore, in a case where the luminous body is a light-emitting diode element, preferably, a light emission surface of the light-emitting diode element included in each of the group of light sources categorized into the first light source faces a direction inclined to the side of the one end of the case member with respect to the normal direction to the light output surface, and a light emission surface of the light-emitting diode element included in each of the group of light sources categorized into the second light source faces a direction inclined to the side of the other end of the case member with respect to the normal direction to the light output surface.

A liquid crystal display device according to a second aspect of this invention includes the above-described illuminating device according to the first aspect and a liquid crystal display panel that is irradiated with light from the illuminating device. According to this configuration, it is easily possible to suppress luminance deterioration due to variations in visual angle.

### Advantageous Effects of the Invention

As described thus far, according to the present invention, it is easily achievable to obtain an illuminating device that can suppress luminance deterioration due to variations in visual angle, and a liquid crystal display device provided with the same.

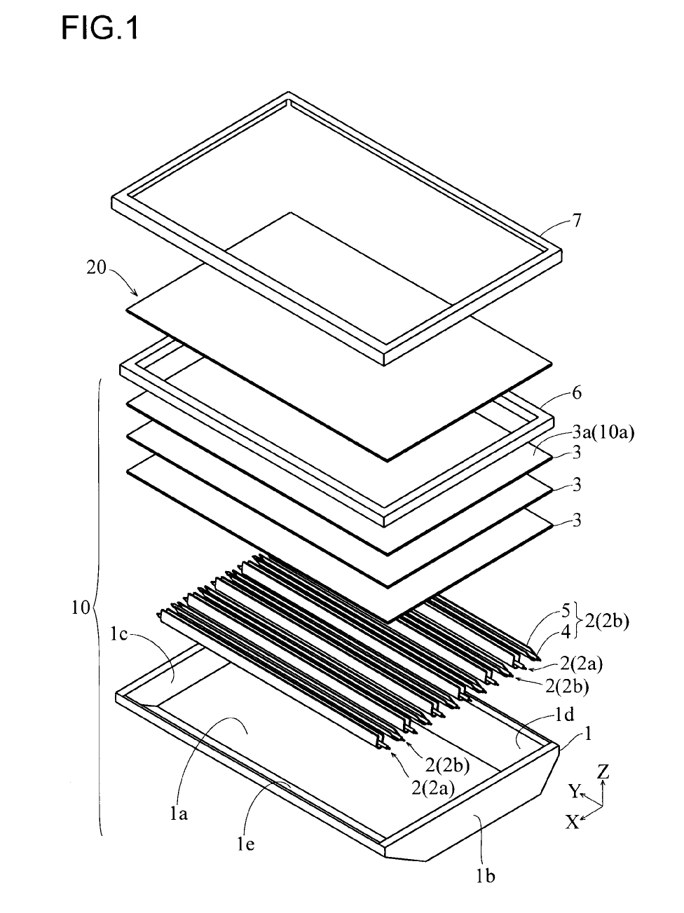

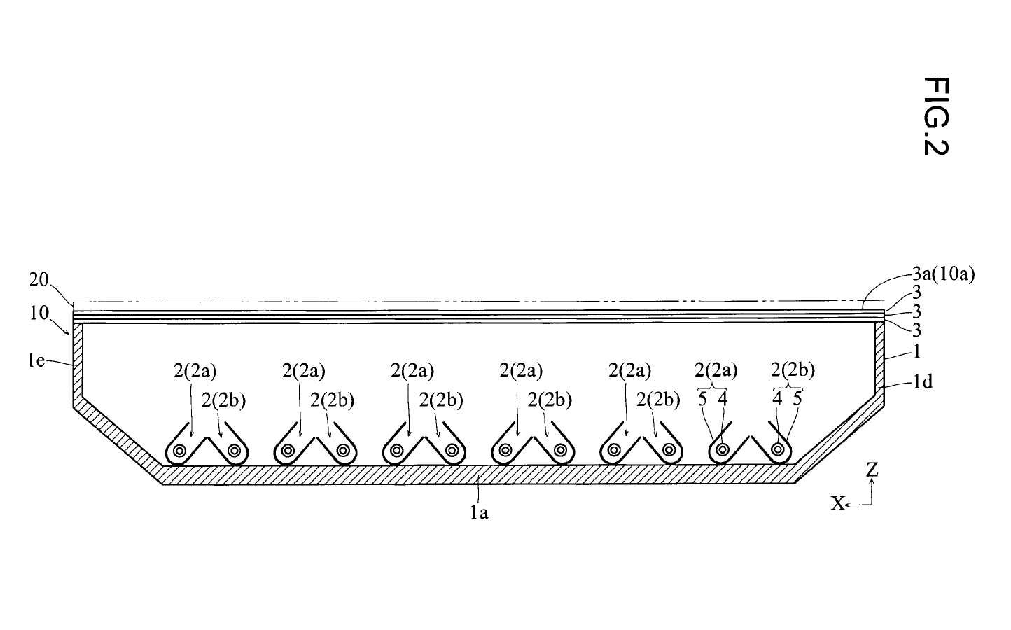

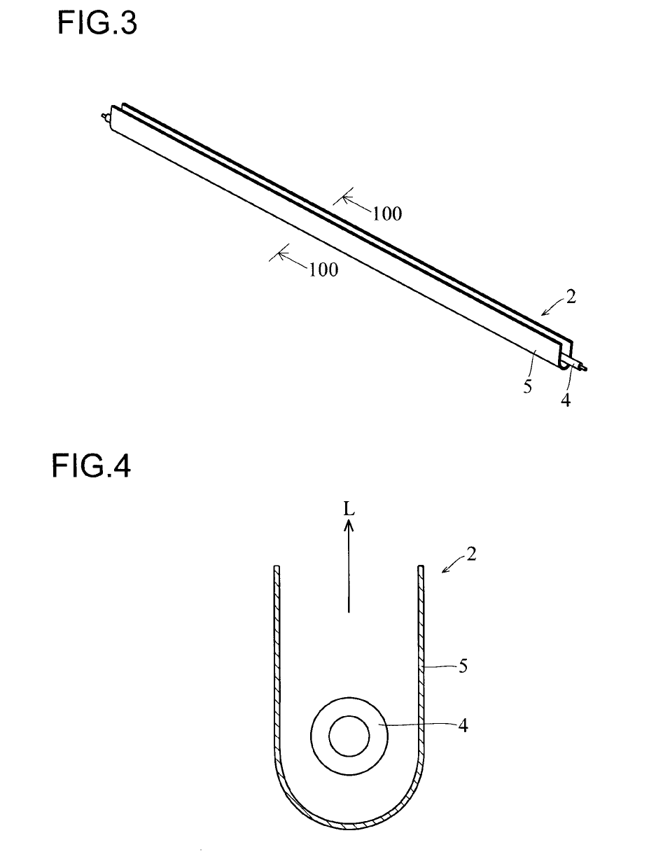

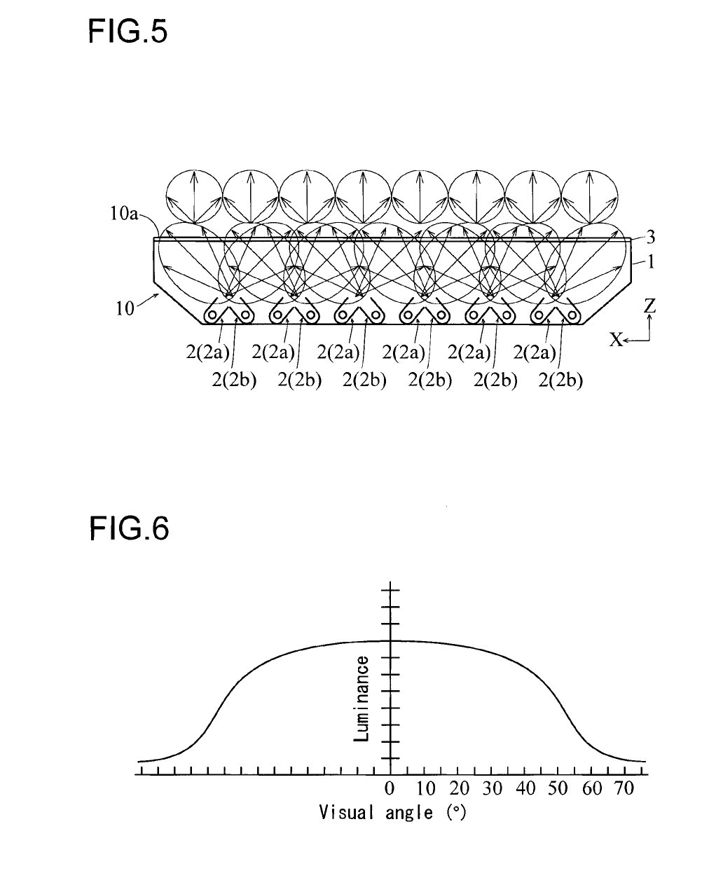

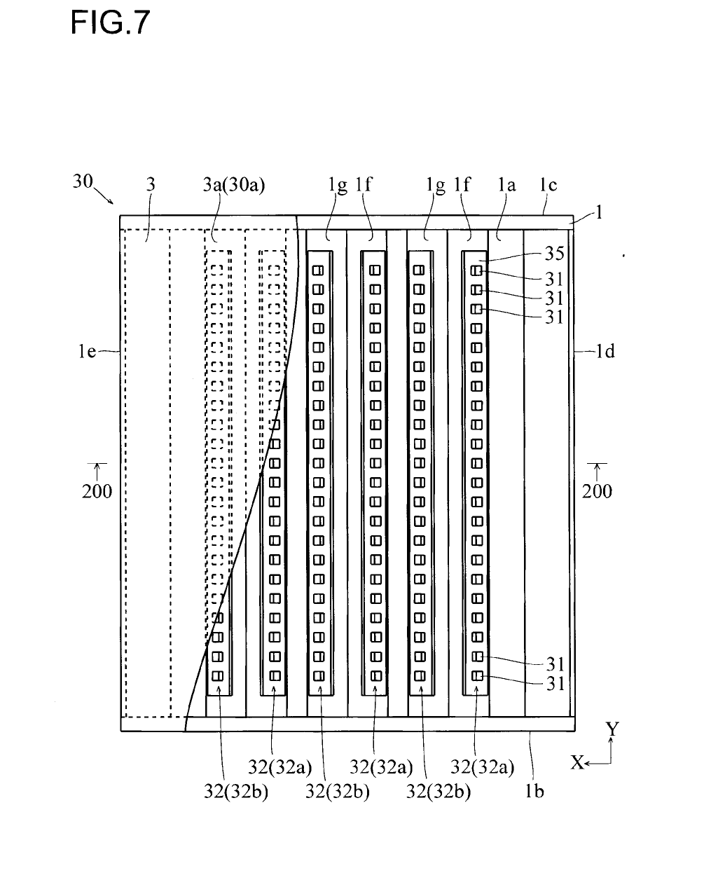

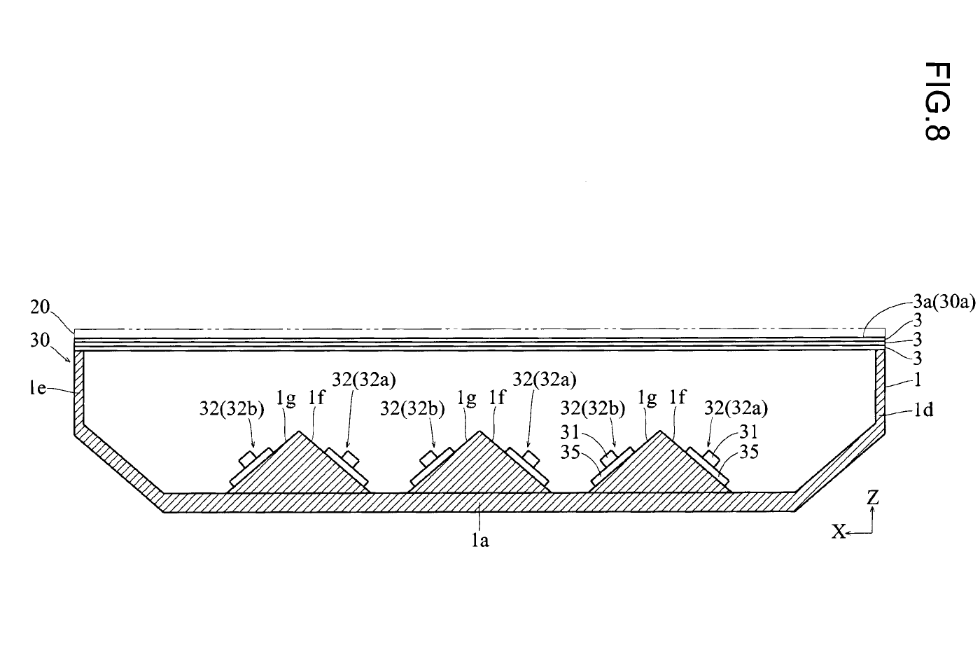

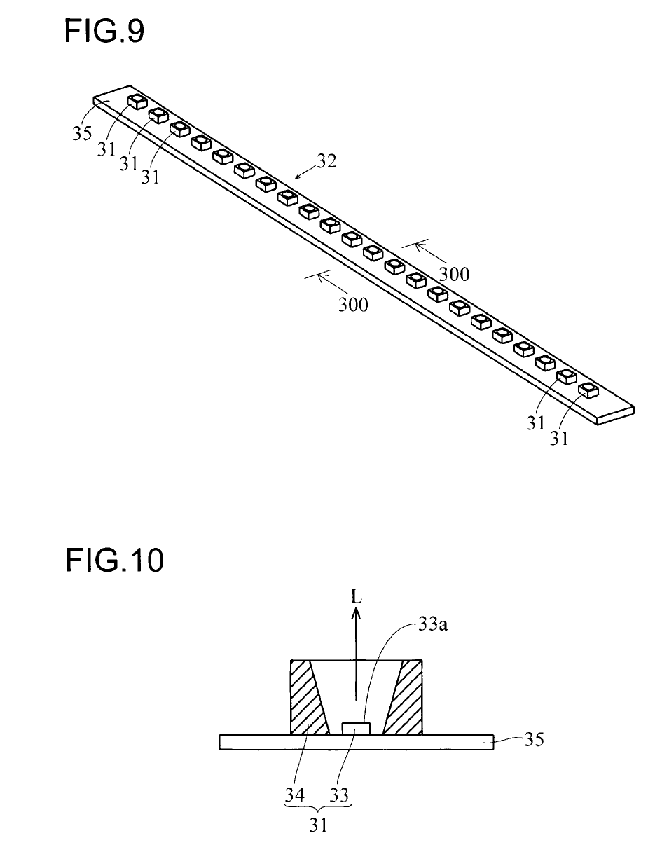

### BRIEF DESCRIPTION OF DRAWINGS

[FIG. 1] An exploded perspective view of an illuminating device according to a first embodiment of the present invention.

[FIG. 2] A cross-sectional view of the illuminating device according to the first embodiment shown in FIG. 1.

[FIG. 3] A perspective view of a light source of the illuminating device according to the first embodiment shown in FIG. 1.

[FIG. 4] A cross-sectional view taken along a line 100-100 of FIG. 3.

[FIG. 5] A diagram for explaining effects of the first embodiment (diagram showing light behavior).

[FIG. 6] A diagram for explaining the effects of the first embodiment (diagram showing a luminance versus visual angle characteristic).

[FIG. 7] A plan view of an illuminating device according to a second embodiment of the present invention.

[FIG. 8] A cross-sectional view taken along a line 200-200 of FIG. 7.

[FIG. 9] A perspective view of a light source of the illuminating device according to the second embodiment shown in FIG. 7.

[FIG. 10] A cross-sectional view taken along a line 300-300 of FIG. 9.

[FIG. 11] A simplified diagram of an example of a direct type backlight (illuminating device) according to the conventional technique.

[FIG. 12] A diagram for explaining a problem with the conventional technique (diagram showing light behavior).

[FIG. 13] A diagram for explaining the problem with the conventional technique (diagram showing a luminance versus visual angle characteristic).

### DESCRIPTION OF EMBODIMENTS

### First Embodiment

The description is directed first to the configuration of an illuminating device 10 according to a first embodiment with reference to FIGS. 1 to 4.

As shown in FIG. 1, the illuminating device 10 of the first embodiment is used as a backlight installed in a liquid crystal display device and is configured to generate planar light and to irradiate a liquid crystal display panel (illuminated body) 20 with the generated light from a back surface side of the liquid crystal display panel 20. Furthermore, the illuminating device 10 of the first embodiment is of the direct type in which a light source of the illuminating device 10 is disposed immediately below the liquid crystal display panel 20.

Specifically, in this structure, as shown in FIGS. 1 and 2, the illuminating device 10 of the first embodiment includes at least a case member 1, a plurality of linear light sources 2 as a light source, and optical sheets 3.

The case member 1 is intended to house the plurality of linear light sources 2 and is formed in the shape of a box having a light output opening on a side on which the liquid crystal display panel 20 is installed. That is, the case member 1 includes a bottom portion 1a having a rectangular shape when seen two-dimensionally and four side portions 1b to 1e provided in a standing manner at the outer periphery of the bottom portion 1a. A space on an upper surface side of the bottom portion 1a of the case member 1, which is surrounded by the four side portions 1b to 1e, is used as a housing space, and the plurality of linear light sources 2 are housed in the housing space. In the following description, the lateral direction of the case member 1 is referred to as an X-direction, and the longitudinal direction of the case member 1 is referred to as a Y-direction.

Furthermore, the case member 1 is configured so that an inner surface thereof (surface facing the side of the housing space) reflects light. Thus, in the housing space of the casing member 1, light from the plurality of linear light sources 2 can be effectively made to travel toward the side of the liquid crystal display panel 20. The case member 1 as described above can be obtained by, for example, molding a resin material having reflectivity such as polycarbonate resin into a box shape. Furthermore, the case member 1 may be obtained also by forming a metal sheet into a box shape by sheet-metal processing, and applying a white-based sheet onto an inner surface (surface facing the side of the housing space) of the box, or subjecting the inner surface to white printing.

As shown in FIGS. 3 and 4, each of the plurality of linear light sources 2 includes a fluorescent tube 4 for generating light and a reflector 5 for reflecting light generated by the florescent tube 4. The fluorescent tube 4 is an example of the “luminous body” of the present invention, and the reflector 5 is an example of the “reflection member” of the present invention.

The fluorescent tube 4 is of the straight tube type and disposed in a manner that both end portions thereof are held at the side portions 1b and 1c (see FIG. 1) on the short sides of the case member 1, respectively. Furthermore, the reflector 5 is made of, for example, a silver-deposited film bent into a U shape and covers a predetermined portion of the fluorescent tube 4. The reflector 5 covering the predetermined portion of the fluorescent tube 4 defines a light emission direction of each of the linear light sources 2, which is a direction indicated by an arrow L in FIG. 4.

As shown in FIGS. 1 and 2, the plurality of linear light sources 2, in a state of being housed in the housing space of the case member 1 (state where both the end portions of the fluorescent tube 4 are held at the side portions 1b and 1c on the short sides of the case member 1, respectively), are disposed immediately below the liquid crystal display panel 20 (optical sheets 3). Moreover, the plurality of linear light sources 2 are disposed at a predetermined spacing from each other in the X-direction so that they each extend in the Y-direction. That is, the plurality of linear light sources 2 are arranged from the side of one end (side of the side portion 1d on one of the long sides) of the case member 1 toward the side of the other end (side of the side portion 1e on the other of the long sides).

The optical sheets 3 are intended to, for example, diffuse and condense light from the plurality of linear light sources 2 and disposed so as to close the light output opening of the case member 1. Light transmitted through the optical sheets 3 illuminates the liquid crystal display panel 20 as illumination light. That is, a light output surface (surface through which illumination light for illuminating the liquid crystal display panel 20 is outputted) 10a of the illuminating device 10 is constituted by an uppermost surface (surface facing the side of the liquid crystal display panel 20) 3a of the optical sheets 3.

Here, in the first embodiment, the plurality of linear light sources 2 are categorized into two types that are a first light source 2a and a second light source 2b. Each of a group of linear light sources among the plurality of linear light sources 2, which are categorized into the first light source 2a, has a light emission direction inclined to the side of the one end (side of the side portion 1d on the one of the long sides) of the case member 1 with respect to a Z-direction (normal direction to the light output surface 10a of the illuminating device 10), and each of a group of linear light sources among the plurality of linear light sources 2, which are categorized into the second light source 2b, has a light emission direction inclined to the side of the other end (side of the side portion 1e on the other of the long sides) of the case member 1 with respect to the Z-direction.

Specifically, in the first embodiment, a light reflection direction of the reflector 5 included in each of the group of the linear light sources 2 categorized into the first light source 2a is inclined to the side of the one end (side of the side portion 1d on the one of the long sides) of the case member 1 with respect to the Z-direction, and a light reflection direction of the reflector 5 included in each of the group of the linear light sources 2 categorized into the second light source 2b is inclined to the side of the other end (side of the side portion 1e on the other of the long sides) of the case member 1 with respect to the Z-direction. The plurality of linear light sources 2 are arranged from the side of the one end of the case member 1 toward the side of the other end so that the group of the linear light sources 2 categorized into the first light source 2a and the group of the linear light sources 2 categorized into the second light source 2b alternate with each other one by one.

Furthermore, as shown in FIG. 1, a frame-shaped chassis 6 made of a resin molded article, sheet metal, or the like is attached to the light output opening of the case member 1. The liquid crystal display panel 20 illuminated by the illuminating device 10 is supported by the chassis 6. Furthermore, the liquid crystal display panel 20 supported by the chassis 6 is fixed by being held down at its outer periphery by a bezel 7 made of a metal sheet (such as a stainless steel sheet or a galvanized steel sheet).

In the first embodiment, as described in the foregoing, the plurality of linear light sources 2 are categorized into two types that are the first light source 2a and the second light source 2b, and each of the group of the linear light sources 2 categorized into the first light source 2a is set to have a light emission direction inclined to the side of the one end (side of the side portion 1d on the one of the long sides) of the case member 1 with respect to the Z-direction (normal direction to the light output surface 10a of the illuminating device 10), and each of the group of the linear light sources 2 categorized into the second light source 2b is set to have a light emission direction inclined to the side of the other end (side of the side portion 1e on the other of the long sides) of the case member 1 with respect to the Z-direction. By this configuration, as shown in FIGS. 5 and 6, while the luminance of light outputted in the front direction (Z-direction) is somewhat decreased, the luminance of light outputted in a direction inclined with respect to the front direction is increased compared with that in the conventional configuration. Thus, even under a visual angle in a direction deviated from the front direction, the occurrence of the trouble that the luminance is deteriorated can be suppressed. That is, luminance deterioration due to variations in visual angle can be suppressed, which allows excellent luminance to be obtained under a wider range of visual angles. In FIG. 5, the length of each arrow represents light luminance.

In this case, since the group of the linear light sources 2 categorized into the first light source 2a and the group of the linear light sources 2 categorized into the second light source 2b are arranged so as to alternate with each other one by one, even if the light emission direction varies between the group of the linear light sources 2 categorized into the first light source 2a and the group of the linear light sources 2b categorized into the second light source 2b, the occurrence of luminance variations can be suppressed.

Furthermore, in the first embodiment, as described in the foregoing, a light reflection direction of the reflector 5 included in each of the group of the linear light sources 2 categorized into the first light source 2a is inclined to the side of the one end (side of the side portion 1d on the one of the long sides) of the case member 1 with respect to the Z-direction, and a light reflection direction of the reflector 5 included in each of the group of the linear light sources 2 categorized into the second light source 2b is inclined to the side of the other end (side of the side portion 1e on the other of the long sides) of the case member 1 with respect to the Z-direction. By this configuration, it is easily possible to set so that each of the group of the linear light sources 2 categorized into the first light source 2a has a light emission direction inclined to the side of the one end of the case member 1 with respect to the Z-direction, and each of the group of the linear light sources 2 categorized into the second light source 2b has a light emission direction inclined to the side of the other end of the case member 1 with respect to the Z-direction.

Furthermore, when the above-described configuration of the first embodiment is applied to a backlight of a so-called dual view type liquid crystal display device with which different images can be viewed from different lateral directions, respectively, these images when viewed from the respective lateral directions can be increased in luminance to the same level.

### Second Embodiment

The description is directed next to the configuration of an illuminating device 30 according to a second embodiment with reference to FIGS. 7 to 10.

In the illuminating device 30 of the second embodiment, as shown in FIGS. 7 and 8, two or more point-shaped light sources 31 arranged in a row are used as a linear light source 32, and a plurality of the linear light sources 32 are housed in a housing space of a case member 1. The plurality of the linear light sources 32, in a state of being housed in the housing space of the case member 1, are disposed immediately below a liquid crystal display panel 20 (optical sheets 3) and arranged from the side of one end (side of a side portion 1d on one of the long sides) of the case member 1 toward the side of the other end (side of a side portion 1e on the other of the long sides) at a predetermined spacing from each other.

Now, as shown in FIGS. 9 and 10, each of the two or more point-shaped light sources 31 constituting each of the linear light sources 32 includes a light-emitting diode element (LED) 33 that generates light and a reflective frame body 34 that reflects light generated by the LED 33. The two or more point-shaped light sources 31 are mounted on a single substrate 35 and thus are formed into a module. Each of the point-shaped light sources 31 has a light emission direction indicated by an arrow L in FIG. 10. The LED 33 is an example of the “luminous body” of the present invention, and the reflective frame body 34 is an example of the “reflection member” of the present invention.

Furthermore, as shown in FIGS. 7 and 8, a light output opening of the case member 1 is closed by the optical sheets 3, and light transmitted through the optical sheets 3 illuminates the liquid crystal display panel 20 as illumination light. That is, a light output surface (surface through which illumination light for illuminating the liquid crystal display panel 20 is outputted) 30a of the illuminating device 30 is constituted by an uppermost surface (surface facing the side of the liquid crystal display panel 20) of the optical sheets 3.

Here, in the second embodiment, the plurality of the linear light sources 32 are categorized into two types that are a first light source 32a and a second light source 32b. Each of a group of linear light sources among the plurality of the linear light sources 32, which are categorized into the first light source 32a, has a light emission direction inclined to the side of the one end (side of the side portion 1d on the one of the long sides) of the case member 1 with respect to a Z-direction (normal direction to the light output surface 30a of the illuminating device 30), and each of a group of linear light sources among the plurality of the linear light sources 32, which are categorized into the second light source 32b, has a light emission direction inclined to the side of the other end (side of the side portion 1e on the other of the long sides) of the case member 1 with respect to the Z-direction. Moreover, the group of the linear light sources 32 categorized into the first light source 32a and the group of the linear light sources 32 categorized into the second light source 32b are arranged so as to alternate with each other one by one.

Specifically, in the second embodiment, mounting surfaces 1f and 1g inclined to different directions from each other are provided on a bottom portion 1a of the case member 1, and the mounting surfaces 1f and 1g of the case member 1 are arranged from the side of the one end (side of the side portion 1d on the one of the long sides) of the case member 1 toward the side of the other end (side of the side portion 1e on the other of the long sides) so as to alternate with each other one by one. Each of the mounting surfaces 1f as one type of mounting surfaces of the case member 1 is a surface facing a direction inclined to the side of the one end of the case member 1 with respect to the Z-direction, and each of the mounting surfaces 1g as the other type of mounting surfaces of the case member 1 is a surface facing a direction inclined to the side of the other end of the case member 1 with respect to the Z-direction. The group of the linear light sources 32 categorized into the first light source 32a are mounted on the mounting surfaces if as one type of mounting surfaces of the case member 1, and the group of the linear light sources 32 categorized into the second light source 32b are mounted on the mounting surfaces 1g as the other type of mounting surfaces of the case member 1.

Thus, as for the group of the linear light sources 32 categorized into the first light source 32a, a light emission surface 33a (see FIG. 10) of each of the LEDs 33 included therein faces a direction inclined to the side of the one end (side of the side portion 1d on the one of the long sides) of the case member 1 with respect to the Z-direction, so that the light emission direction thereof is inclined to the side of the one end of the case member 1 with respect to the Z-direction. Furthermore, as for the group of the linear light sources 32 categorized into the second light source 32b, the light emission surface 33a of each of the LEDs 33 included therein faces a direction inclined to the side of the other end (side of the side portion 1e on the other of the long sides) of the case member 1 with respect to the Z-direction, so that the light emission direction thereof is inclined to the side of the other end of the case member 1 with respect to the Z-direction. Moreover, in this case, a light reflection direction of each of the reflective frame bodies 34 (see FIG. 10) included in the group of the linear light sources 32 categorized into the first light source 32a is inclined to the side of the one end of the case member 1 with respect to the Z-direction, and a light reflection direction of each of the reflective frame bodies 34 included in the group of the linear light sources 32 categorized into the second light source 32b is inclined to the side of the other end of the case member 1 with respect to the Z-direction.

Other constituent components of the second embodiment have configurations similar to those in the foregoing first embodiment.

Similarly to the foregoing first embodiment, the illuminating device 30 of the second embodiment configured as above can provide effects such as suppressing luminance deterioration due to variations in visual angle.

The embodiments disclosed in this application are to be considered in all respects as illustrative and not limiting. The scope of the present invention is indicated by the appended claims rather than by the foregoing description of the embodiments, and all changes which come within the meaning and range of equivalency of the claims are intended to be embraced therein.

### LIST OF REFERENCE SIGNS

1 Case member

2, 32 Linear light source (Light source)

2a, 32a First light source

2b, 32b Second light source

3 Optical sheet

3a, 10a, 30a Light output surface

4 Fluorescent tube (Luminous body)

5 Reflector (Reflection member)

10, 30 Illuminating device

20 Liquid crystal display panel (Illuminated body)

33 LED (Luminous body)

33a Light emission surface

34 Reflective frame body (Reflection member)

1. An illuminating device, comprising:
a case member that has a light output opening on a side on which an illuminated body is installed;
a plurality of light sources that, in a state of being housed in the case member, are disposed immediately below the illuminated body and arranged from a side of one end of the case member toward a side of the other end; and
an optical sheet that is disposed so as to close the light output opening of the case member and whose surface facing the side of the illuminated body acts as a light output surface,
wherein the plurality of light sources are categorized into at least two types that are a first light source and a second light source, and
each of a group of light sources among the plurality of light sources, which are categorized into the first light source, has a light emission direction inclined to the side of the one end of the case member with respect to a normal direction to the light output surface, and each of a group of light sources among the plurality of light sources, which are categorized into the second light source, has a light emission direction inclined to the side of the other end of the case member with respect to the normal direction to the light output surface.

2. The illuminating device according to claim 1, wherein
the plurality of light sources are arranged from the side of the one end of the case member toward the side of the other end so that the group of light sources categorized into the first light source and the group of light sources categorized into the second light source alternate with each other one by one.

3. The illuminating device according to claim 1, wherein
each of the plurality of light sources comprises a luminous body that generates light and a reflection member that reflects light generated by the luminous body, and
a light reflection direction of the reflection member included in each of the group of light sources categorized into the first light source is inclined to the side of the one end of the case member with respect to the normal direction to the light output surface, and a light reflection direction of the reflection member included in each of the group of light sources categorized into the second light source is inclined to the side of the other end of the case member with respect to the normal direction to the light output surface.

4. The illuminating device according to claim 3, wherein
the luminous body is a fluorescent tube.

5. The illuminating device according to claim 3, wherein
the luminous body is a light-emitting diode element.

6. The illuminating device according to claim 5, wherein
a light emission surface of the light-emitting diode element included in each of the group of light sources categorized into the first light source faces a direction inclined to the side of the one end of the case member with respect to the normal direction to the light output surface, and a light emission surface of the light-emitting diode element included in each of the group of light sources categorized into the second light source faces a direction inclined to the side of the other end of the case member with respect to the normal direction to the light output surface.

7. A liquid crystal display device, comprising:
the illuminating device according to claim 1, and
a liquid crystal display panel that is irradiated with light from the illuminating device.

8. The illuminating device according to claim 2, wherein
each of the plurality of light sources comprises a luminous body that generates light and a reflection member that reflects light generated by the luminous body, and
a light reflection direction of the reflection member included in each of the group of light sources categorized into the first light source is inclined to the side of the one end of the case member with respect to the normal direction to the light output surface, and a light reflection direction of the reflection member included in each of the group of light sources categorized into the second light source is inclined to the side of the other end of the case member with respect to the normal direction to the light output surface.

9. The illuminating device according to claim 8, wherein
the luminous body is a fluorescent tube.

10. The illuminating device according to claim 8, wherein
the luminous body is a light-emitting diode element.

11. The illuminating device according to claim 10, wherein
a light emission surface of the light-emitting diode element included in each of the group of light sources categorized into the first light source faces a direction inclined to the side of the one end of the case member with respect to the normal direction to the light output surface, and a light emission surface of the light-emitting diode element included in each of the group of light sources categorized into the second light source faces a direction inclined to the side of the other end of the case member with respect to the normal direction to the light output surface.

12. A liquid crystal display device, comprising:
the illuminating device according to claim 2, and
a liquid crystal display panel that is irradiated with light from the illuminating device.

13. A liquid crystal display device, comprising:
the illuminating device according to claim 3, and
a liquid crystal display panel that is irradiated with light from the illuminating device.

14. A liquid crystal display device, comprising:
the illuminating device according to claim 4, and
a liquid crystal display panel that is irradiated with light from the illuminating device.

15. A liquid crystal display device, comprising:
the illuminating device according to claim 5, and
a liquid crystal display panel that is irradiated with light from the illuminating device.

16. A liquid crystal display device, comprising:
the illuminating device according to claim 6, and
a liquid crystal display panel that is irradiated with light from the illuminating device.

17. A liquid crystal display device, comprising:
the illuminating device according to claim 8, and
a liquid crystal display panel that is irradiated with light from the illuminating device.

18. A liquid crystal display device, comprising:
the illuminating device according to claim 9, and
a liquid crystal display panel that is irradiated with light from the illuminating device.

19. A liquid crystal display device, comprising:
the illuminating device according to claim 10, and
a liquid crystal display panel that is irradiated with light from the illuminating device.

20. A liquid crystal display device, comprising:
the illuminating device according to claim 11, and
a liquid crystal display panel that is irradiated with light from the illuminating device.
